(19) United States
(12) Patent Application Publication
(10) Pub. No.: US 2022/0170495 A1
(43) Pub. Date: Jun. 2, 2022

(54) Support Sleeve And Arrangement Of Support Sleeve

(71) Applicant: BBA S.r.l., CENTOBUCHI DI MONTEPRANDONE (AP) (IT)

(72) Inventor: Paul Hanratty, Warsash Southampton (GB)

(21) Appl. No.: 17/539,743

(22) Filed: Dec. 1, 2021

(30) Foreign Application Priority Data
Dec. 2, 2020 (EP) 20 211 366.8

(51) Int. Cl. F16B 7/04

(52) U.S. Cl. CPC F16B 7/0413

(57) ABSTRACT

A support sleeve and an arrangement for supporting spaced-apart components or component portions, wherein the support sleeve is of one-part form and comprises a shaft having a first shaft portion, a second shaft portion adjoining the first shaft portion in an axial direction, and a third shaft portion adjoining the second shaft portion in the axial direction, wherein the first shaft portion and the third shaft portion form opposite ends of the support sleeve, wherein the second shaft portion comprises a retaining means that protrudes radially outward in relation to the first shaft portion and the third shaft portion and can be deformed radially inward counter to a restoring force, and wherein the shaft comprises a slot over the entire axial length of the shaft.

### FIELD OF THE INVENTION

The present invention relates to a support sleeve, to a method for producing such a support sleeve, and to an arrangement comprising such a support sleeve, a hollow body and a fastening means.

### BACKGROUND OF THE INVENTION

In practice, it is often difficult to avoid deformation of a hollow body when forces are acting on the hollow body, for example as a result of a further component being fastened to the hollow body. It is in particular difficult to avoid deformation when there are two opposite walls of the hollow body which are spaced apart in an axial direction and axial forces are acting. In the present case, a hollow body is understood to mean any component that comprises two walls which are spaced apart in an axial direction, an intermediate space consequently being formed between the two walls. It is by all means conceivable that a soft material, which is consequently not dimensionally stable, such as for example an insulating material, in particular a foam, is arranged in the intermediate space. The hollow body does not necessarily need to have fully enclosing walls. The hollow body can by all means also be of U-shaped form, wherein the two legs of the U-shaped profile form the opposite walls which are spaced apart in the axial direction.

Although it is possible for support means to be introduced between two spaced-apart components, a problem with this kind of support is that it is often necessary to handle the two spaced-apart components or the hollow body comprising the two components without there being the risk of the position of a support means introduced between the two components or component portions changing. To avoid a change in position of the support means, it is at present customary for such support means to be fixed in at least one of the components in a relatively complex manner, for example by forming, clinching, adhesive bonding or welding. These measures are very complex, and there is also the risk that the component or the corresponding component portion is damaged when these fixing measures are being carried out.

### OBJECTS OF THE INVENTION

It is therefore an object of the present invention to provide an article that solves the aforementioned problems. It is also an object of the present invention to specify a method for producing this article. It is also an object of the present invention to specify an arrangement that solves the aforementioned problems.

These objects are achieved by way of a support sleeve, a method for producing the support sleeve, and an arrangement of the support sleeve, a hollow body and a fastening means, having the features and advantages described herein and illustrated by the accompanying drawing figures.

### SUMMARY OF THE INVENTION

The support sleeve according to the invention is used in particular to support spaced-apart components or component portions. The support sleeve is of one-part form, wherein the support sleeve comprises a shaft having a first shaft portion, a second shaft portion adjoining the first shaft portion in the axial direction, and a third shaft portion adjoining the second shaft portion in the axial direction. In this case, the third shaft portion forms an end of the support sleeve. The second shaft portion comprises a retaining means, wherein the retaining means protrudes radially outward in relation to the first and the third shaft portion and can be deformed radially inward counter to a restoring force. The shaft comprises a slot over the entire axial length of the shaft.

After such a support sleeve has been introduced into a corresponding through-opening in a wall of a component, for example of a hollow body, from a first side of the wall, the retaining means retains the support sleeve in the wall and prevents the support sleeve from undesirably coming loose or falling out of the wall. The support sleeve is thus mounted in the wall in a virtually captive manner by the retaining means. This means the component can be handled without any particular precautionary measures. In particular, complex measures for fixing the support sleeve in the wall, such as for example forming, clinching, adhesive bonding or welding, can be dispensed with. It is by all means conceivable for the support sleeve to be retained in the wall in a force-fitting manner by way of the retaining means. However, the support sleeve is preferably retained on the wall in a form-fitting manner by way of the retaining means. Preferably, the restoring force causes the retaining means to deform radially outward on a second side of the wall situated opposite the first side, such that after the support sleeve has been introduced into the component, the retaining means or at least a subregion of the retaining means engages behind the wall in the axial direction. The first shaft portion is preferably arranged in the through-opening. As a result, the support sleeve is also mounted in the wall in a captive manner in a radial direction.

By virtue of the fact that the support sleeve is of one-part form, it can be produced in a particularly simple manner. The one-part form also makes the handling easier. By way of example, it is not necessary for a certain sequence to be observed during the assembly of the support sleeve in the wall or in the hollow body and/or for the support sleeve to first be pre-assembled. Rather, the use of the support sleeve is very simple: the support sleeve merely has to be introduced through the through-opening. As a result, assembly errors are avoided.

As a result of the slot, the deformation of the shaft in the radial direction is made easier or made possible, or at least the extent of the deformation is increased compared with a shaft without a slot. This in turn simplifies the assembly, since it is still possible to introduce the support sleeve even in the case of only a small amount of play or no play between the dimensions of the through-opening and the dimensions of the non-deformed shaft. In the case of a large amount of play, the shaft can also be widened in advance or subsequently in order to reduce the radial play of the shaft in the through-opening. This means one and the same support sleeve is suitable for a wide range of dimensions of the through-opening. This makes a reduction in warehousing possible.

As regards the slot, it is considered to be particularly advantageous if the slot extends over the entire axial length of the support sleeve.

Preferably, the slot is rectilinear and/or configured parallel to the axial direction. When the slot is configured parallel to the axial direction, the slot has hardly any adverse effect on the stability of the support sleeve with respect to axially acting forces.

The slot preferably has a constant slot width.

With regard to a particularly high stability, in particular for the purpose of absorbing axial forces, it is considered to be advantageous if the shaft comprises exactly one slot.

In this respect, it is also considered to be particularly advantageous if the third shaft portion and/or the first shaft portion, preferably the third shaft portion and the first shaft portion, particularly preferably the entire shaft, is free of any other material weakening apart from the slot, for example through-openings, further slots, apertures and/or bores.

It is considered to be particularly advantageous if a subregion of the first shaft portion protrudes in relation to the retaining means counter to the axial direction.

In respect of a particularly simple manufacturing process and nevertheless high stability regarding the absorption of axial forces, it is considered to be advantageous if the third shaft portion has a constant cross section over the entire axial length of the third shaft portion, in particular the shaft has a constant cross section over the entire axial length of the shaft except for in the region of the retaining means.

The first shaft portion and the third shaft portion preferably have a closed lateral surface.

The shaft preferably comprises a wall, wherein the wall runs parallel to the axial direction over the entire axial length of the third shaft portion, in particular over the entire axial length of the third shaft portion and over the entire axial length of the first shaft portion, preferably over the entire axial length of the shaft.

The shaft preferably has an outer contour in a section plane perpendicular to the axial direction, wherein the outer contour is circular or elliptical, or the outer contour has the shape of a polygon, in particular a polygon with rounded corners.

It is considered to be particularly advantageous if the retaining means comprises a plurality of retaining elements. It is for example possible for the retaining elements to be in the form of retaining lugs, beads or webs.

In the case of a plurality of retaining elements, it is considered to be particularly advantageous if these are arranged in an encircling manner. The retaining elements are preferably arranged in the same plane in the axial direction. This makes it easier to introduce the support sleeve into a through-opening in a wall because the support sleeve is prevented from tilting when it is being introduced.

The retaining elements are in particular arranged in a rotationally symmetrical manner with respect to an axis configured in the axial direction, wherein an order of symmetry is n>1, preferably the order of symmetry n corresponds to the number of retaining elements.

The support sleeve is in particular configured to receive a fastening means that passes through the support sleeve. For this purpose, it is considered to be advantageous if the support sleeve has, at opposite ends in the axial direction, a respective opening that can be passed through in the axial direction.

It is considered to be particularly advantageous if the support sleeve comprises a head portion, wherein the first shaft portion adjoins the head portion in the axial direction, wherein the head portion protrudes radially outward in relation to the third shaft portion, preferably protrudes radially outward in relation to the retaining means. The head portion serves in particular as a stop in order to prevent the support sleeve from being introduced any further into a through-opening in a wall as soon as the head portion bears against the wall. The head portion also prevents the support sleeve from falling out of the through-opening in the axial direction. The head portion is preferably designed in such a way that it comes to bear on the first side of the wall, the support sleeve being introduced into the through-opening from said first side.

The head portion preferably has a cross section that tapers in the direction of the shaft. In particular, the head portion is in the form of a countersunk head.

The radial protrusion of the retaining means, in particular of the respective retaining element, preferably increases counter to the axial direction. In particular, the retaining means, preferably the respective retaining element, is of wedge-like form. This design makes it easier to introduce the support sleeve into a through-opening in a wall, since the increase in cross section or the wedge shape favors an action of force on the retaining means or the retaining elements in the radially inward direction during the introduction operation.

The retaining means particularly preferably comprises a plurality of retaining elements in the form of webs, wherein the respective web is connected in the region of an end of the web, in particular in the region of an end of the web facing the third shaft portion, to the rest of the shaft, and the other end of the respective web is a free end.

It is considered to be particularly advantageous if the second shaft portion comprises an aperture for receiving the webs when the webs are being radially inwardly deformed, or wherein the second shaft portion comprises a respective aperture for receiving the respective web when the respective web is being radially inwardly deformed.

The design with apertures is conducive to the web being able to be radially inwardly deformed to a particularly great extent.

In particular, the respective aperture has a tangential extent, wherein the tangential extent of the respective aperture is greater than a tangential extent of the respective web. The greater tangential extent avoids a situation whereby tangential deformation of the web obstructs deformation of the web in the radially inward direction. In this respect, there is a certain amount of tangential play between the respective aperture and the respective web.

The aperture may be in the form of a recess or in the form of a through-opening.

Preferably, the support sleeve is formed by a bent metal strip, in particular by a bent metal sheet. The retaining means, in particular the retaining elements, are preferably formed by a bent-out subregion of the metal strip. This type of design of the support sleeve can be produced in a particularly simple and cost-effective manner.

In a preferred embodiment of the support sleeve, the support sleeve is free of materially bonded connections, such as for example a weld seam or similar.

The support sleeve is composed in particular of a metal or a metal alloy. The support sleeve is preferably composed of a steel, preferably a spring steel.

In a preferred embodiment, the shaft of the support sleeve is formed substantially in the manner of a hollow cylinder, in particular in the manner of a hollow cylinder with a circular-ring-shaped base area.

The cross section of the first shaft portion and of the third shaft portion is preferably oval, in particular circular or elliptical.

It is considered to be advantageous if the shaft has an outer contour with a total periphery in a section plane perpendicular to the axial direction, wherein the slot accounts for a proportion of less than or equal to 0.05, preferably less than or equal to 0.03, particularly preferably less than or equal to 0.02, of the total periphery. The proportion is in particular between 0.01 and 0.05. In the case of such an embodiment, sufficient elasticity of the shaft for the purpose of radial deformation of the shaft is ensured while still having high axial stability of the shaft. In the present case, total periphery is to be understood to mean the periphery of the shaft including the slot. By way of example, the total periphery of the outer contour of the shaft in the case of a circular shaft that has an interruption merely in the region of the slot is identical to the corresponding circumference.

The shaft preferably has an outer contour with a total periphery in a section plane perpendicular to the axial direction in the region of the apertures, wherein the apertures account for a proportion of less than or equal to 0.3, preferably less than or equal to 0.08, preferably between 0.06 and 0.3, of the total periphery of the outer contour.

It is considered to be advantageous if the slot has a width of 0.05 mm to 4 mm.

The apertures preferably have a width of 0.05 mm to 4 mm. The width of the apertures is preferably greater than the width of the slot.

The shaft preferably has a wall thickness of 1 mm to 5 mm.

It is considered to be particularly advantageous if the width of the slot amounts to 0.7 times to 1.4 times the wall thickness of the shaft.

It is considered to be advantageous if the shaft has an axial length of 2 cm to 15 cm. The shaft preferably has a width, in particular a diameter, of 1 cm to 4 cm.

An axial length of the retaining means preferably amounts to 5% to 15% of the axial length of the shaft.

The support sleeve is preferably composed merely of the first shaft portion, the second shaft portion and the third shaft portion.

A method according to the invention for producing the support sleeve comprises the following method steps:
producing or providing a, preferably planar, metal strip, in particular a metal sheet, preferably a sheet-metal developed form,
freeing up, in particular by punching and/or lancing and/or cutting, a subregion or a plurality of subregions of the metal strip, wherein the subregion or the respective subregion is connected to the rest of the metal strip via a connecting portion in such a way that the subregion can be bent out in relation to the rest of the metal strip or the respective subregion can be bent out in relation to the metal strip,
bending out the subregion or the subregions in relation to the rest of the metal strip,
bending the metal strip in such a way that the metal strip forms a radially encircling wall for the purpose of forming the shaft of the support sleeve, wherein the bent-out subregion forms a retaining means which protrudes radially outward in relation to the rest of the metal strip or wherein the bent-out subregions form retaining elements which protrude radially outward in relation to the rest of the metal strip.

The method steps are preferably carried out in the sequence described. However, the method steps do not necessarily have to be carried out in the sequence described. For instance, it is also possible for the subregions to be bent out after the metal strip has been bent.

An arrangement according to the invention comprises a support sleeve according to one of the above embodiments and a hollow body. The hollow body comprises two walls which are spaced apart in the axial direction, wherein the first wall of the two walls comprises a first through-opening and the second wall of the two walls comprises a second through-opening. The second through-opening is preferably configured as a second through-opening which is situated opposite the first through-opening in the axial direction. The support sleeve passes through the first through-opening, wherein the retaining means is arranged on a side of the first wall facing the second wall, and the retaining means engages behind the first wall on the side facing the second wall in the axial direction. This results in the formation of a form fit counter to the axial direction, as a result of which the sleeve is prevented from coming loose or falling out of the hollow body. As a result, the hollow body with the support sleeve arranged therein can be handled without the risk of the support sleeve coming loose or falling out. The support sleeve preferably makes contact with the second wall on a side facing the first wall. As a result, there is a reduction in the risk of deformation or the extent of the possible deformation of the hollow body.

The support sleeve preferably makes contact with the second wall directly. This is particularly advantageous if electrical contact is to be achieved between the second wall and the support sleeve.

A radial extent of the third shaft portion and of the first shaft portion is preferably smaller than a radial extent of the first through-opening. This makes it easier to introduce the support sleeve into the first through-opening. The support sleeve can also be displaced to some extent in the radial direction, for example in order to compensate for manufacturing tolerances, in particular with regard to alignment of the two through-openings.

The arrangement preferably comprises a fastening means. The fastening means passes through the support sleeve, the first through-opening and the second through-opening. The fastening means preferably comprises a respective stop element on the mutually averted sides of the two walls, wherein the one stop element can be adjusted in relation to the other stop element in the axial direction. The stop elements serve to brace the fastening means against the hollow body. The fastening means can for example be a screw-and-nut arrangement or an arrangement of a threaded rod and two nuts. Typically, further components are introduced between the hollow body and at least one of the stop elements and are connected to the hollow body in this way. During the bracing of the fastening means against the hollow body, the support sleeve absorbs the forces applied by the bracing, and so deformation of the hollow body is avoided.

The support sleeve preferably makes contact with the second wall on a side facing the first wall.

The arrangement according to one of the above aspects is preferably formed by the following method:
providing a support sleeve according to one of the above embodiments,
providing a hollow body, wherein the hollow body comprises two walls which are spaced apart in the axial direction, wherein the first wall of the two walls comprises a first through-opening and the second wall of the two walls comprises a second through-opening, preferably a second through-opening which is situated opposite the first through-opening in the axial direction,
introducing, preferably manually introducing, the support sleeve into the first through-opening from a side of the first wall, said side facing away from the second wall, in such a way that, during the introduction operation, the retaining means is initially radially inwardly deformed counter to the restoring force and, subsequent to the radially inward deformation, the retaining means deforms radially outward on account of the restoring force, with the result that the retaining means is arranged on a side of the first wall facing the second wall and engages behind the first wall on the side facing the second wall in the axial direction.

### BRIEF DESCRIPTION OF THE DRAWING FIGURES

The invention will be described in more detail on the basis of the accompanying drawing figures, without being restricted to these.

FIG. 1 shows a first embodiment of a support sleeve according to the invention in a partially sectional illustration according to the arrows I in FIG. 2.

FIG. 2 shows the support sleeve in a view according to the arrow II in FIG. 1.

FIG. 3 shows the support sleeve in a view according to the arrow III in FIG. 1.

FIG. 4 shows a further embodiment of a support sleeve according to the invention in a partially sectional view according to the arrows IV in FIG. 5.

FIG. 5 shows the support sleeve in a view according to the arrow V in FIG. 4.

FIG. 6 shows an arrangement according to the invention of a support sleeve, a hollow body and a fastening means in a sectional view.

### DETAILED DESCRIPTION OF THE INVENTION

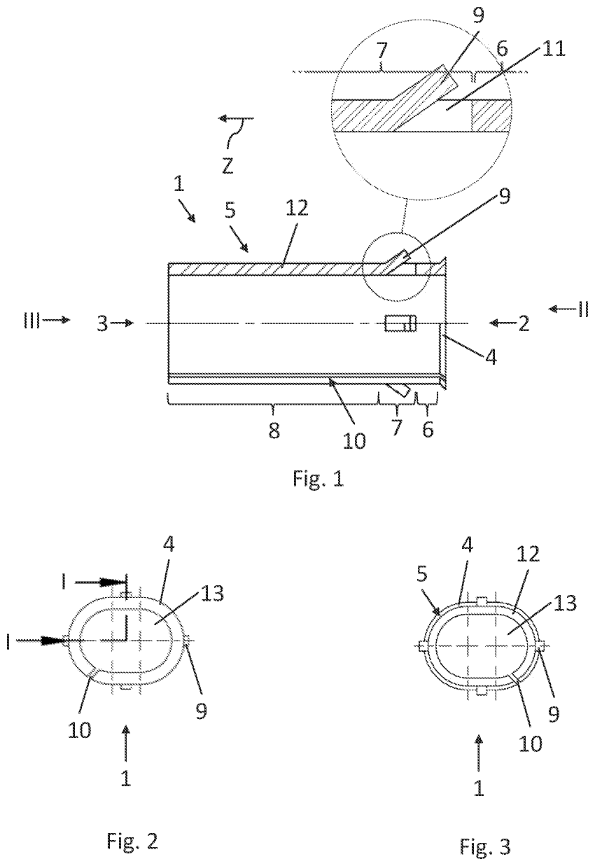

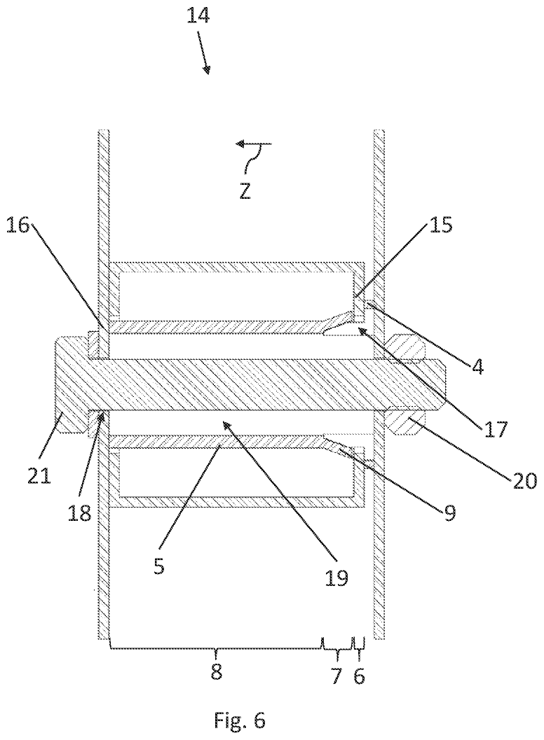

FIGS. 1 to 3 show a first embodiment of the support sleeve 1. The support sleeve 1 serves in particular to absorb axial forces applied by a fastening means 19, in particular to support spaced-apart components or component portions, as is illustrated by way of example in FIG. 6.

The support sleeve 1 comprises a passage opening 13 which is configured in an axial direction Z and which serves to receive the fastening means 19. The support sleeve 1 comprises a shaft 5 having a first shaft portion 6, a second shaft portion 7 adjoining the first shaft portion 6 in the axial direction Z, and a third shaft portion 8 adjoining the second shaft portion 7 in the axial direction Z. In this case, the third shaft portion 8 forms one end 3 of the two opposite ends 2, 3 of the support sleeve 1.

The second shaft portion 7 comprises a retaining means in the form of a plurality of retaining elements 9, wherein each respective retaining element 9 protrudes radially outward in relation to the first and the third shaft portion 6, 8 and can be deformed radially inward counter to a restoring force.

The shaft 5 also comprises a slot 10 over the axial length of the shaft 5, wherein the slot 10 extends over the entire axial length of the support sleeve 1 in the present embodiment.

The support sleeve 1 is of one-part form and is formed by a bent metal strip, in the present case a metal sheet. The retaining elements 9 are formed by bent-out subregions of the metal strip, wherein the retaining elements 9 are in the form of webs in the present case. Each respective web is connected in the region of an end of the web, said end facing the third shaft portion 8, to the rest of the shaft 5. The other end of the respective web is in the form of a free end. The second shaft portion 7 comprises a respective aperture 11 for receiving the respective web when the respective web is being radially inwardly deformed.

In the present case, the support sleeve 1 comprises exactly one slot 10. Accordingly, apart from the exactly one slot 10 and the apertures 11, the shaft 5 or the support sleeve 1 is free of any material weakening, in particular free of any further slots or apertures.

In the present case, the slot 10 is rectilinear and configured parallel to the axial direction Z.

Apart from the apertures 11 and the slot 10, the shaft 5 has a closed lateral surface.

A wall 12 of the shaft 5 has a substantially constant thickness, the thickness of the wall 12 in the present case being greater than a slot width of the slot 10. In the present case, the thickness of the wall 12 is approximately 3 mm and the slot width is approximately 1 mm. The shaft length in the axial direction is approximately 4.2 cm in the present case.

The third shaft portion 8 and the first shaft portion 6 are identical except for their axial extent.

The third shaft portion 8 has a constant cross section over the entire axial length of the third shaft portion 8, wherein this cross section has an oval outer contour which has essentially the shape of two spaced-apart semicircles with connecting webs that connect the semicircles.

In the present case, the slot 10 accounts for a proportion of approximately 0.015 of the total periphery of the outer contour.

In the present case, the support sleeve 1 comprises a head portion 4, wherein the first shaft portion 6 adjoins the head portion 4 in the axial direction Z, wherein the head portion 4 protrudes radially outward in relation to the third shaft portion 8 and the first shaft portion 6. In the present case, the head portion 4 is in the form of a countersunk head. The retaining means, namely the retaining elements 9, protrudes radially in relation to the head portion 4 in the present case. The head portion 4 forms the other end 2 of the two ends 2, 3 of the support sleeve 1 that are situated opposite one another in the axial direction Z.

In the present case, the radial protrusion of the retaining elements 9 increases counter to the axial direction Z, with the result that the retaining elements 9, in their entirety, form an outer contour that decreases conically in the direction of the third shaft portion 8.

An arrangement according to the invention of a support sleeve 1 according to the invention, a hollow body 14 and a fastening means 19 is shown in FIG. 6. The hollow body 14 comprises two walls 15, 16 which are spaced apart in the axial direction Z, wherein the first wall 15 of the two walls 15, 16 comprises a first through-opening 17 and the second wall 16 of the two walls 15, 16 comprises a second through-opening 18, wherein the through-opening 18 and the through-opening 17 are arranged preferably coaxially. The support sleeve 1 passes through the first through-opening 17, wherein the retaining elements 9 are arranged on a side of the first wall 15 facing the second wall 16. The retaining elements 9 engage behind the first wall 15 on the side facing the second wall 16 in the axial direction Z.

In the present case, the support sleeve 1 in turn comprises the head portion 4, wherein the wall 15 is arranged between the head portion 4 and the retaining elements 9. The support sleeve 1 is thus retained with clamping action in the wall 15 by the retaining elements 9 and the head portion 4. In this case, the first shaft portion 6 passes through the through-opening 17 in such a way that the first shaft portion 6 is mounted in the first through-opening 17 with a certain amount of play. The radial play allows the support sleeve 1 to still be oriented to some extent radially. In the present case, the third shaft portion 8 of the support sleeve 1 passes through a further opening of a box-like component, to which the wall 15 is also to be assigned. The third shaft portion 8 comes to bear against the second wall 16 in the axial direction Z and is thus supported in the axial direction Z on the second wall 16. The two walls 15 and 16 are thus supported in relation to one another in the axial direction Z through the intermediary of the support sleeve 1, with the result that the hollow space between the two walls 15, 16 is stiffened.

When axial forces act on one of the two walls 15, 16, in particular when axial forces act on the walls 15, 16 in the direction of the respectively other wall 15, 16, deformation is therefore avoided. Such forces occur for example on account of the fastening means 19, which passes through the support sleeve 1 and the two through-openings 17, 18. The fastening means 19 comprises two stop elements 20, 21, wherein the two stop elements 20, 21 are arranged on mutually averted sides of the two walls 15, 16 and can be adjusted in terms of their respective distance to one another in the axial direction Z. By way of the fastening means 19, which is formed by a screw-and-nut arrangement in the present case, axial forces that are directed toward one another are exerted on the two walls 15, 16. The support sleeve 1 avoids a situation whereby undesired deformation of the two walls 15, 16 occurs when the fastening means 19 are being tightened or braced.

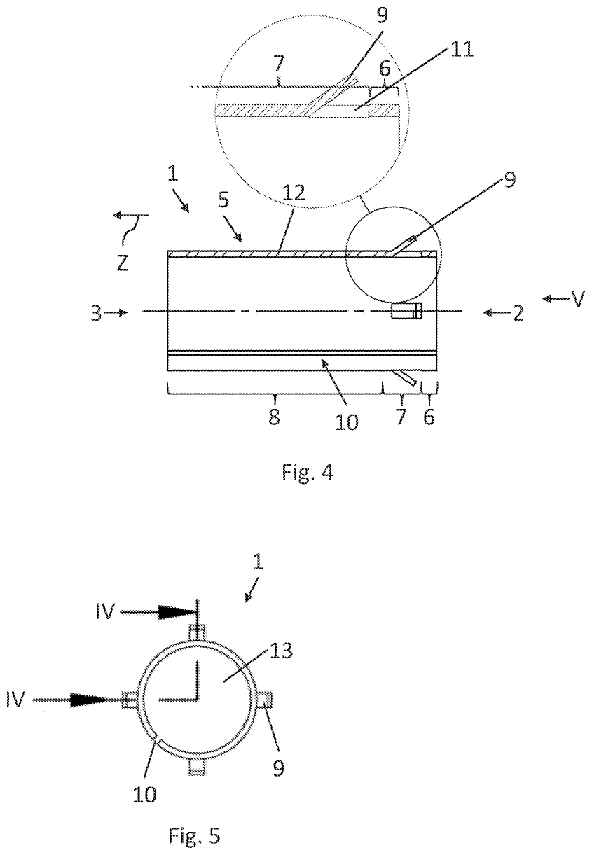

FIGS. 4 and 5 show a further embodiment of a support sleeve 1 according to the invention which essentially differs from the embodiment according to FIGS. 1 to 3 in that the support sleeve 1 comprises no head portion, but is formed solely by the shaft 5. The third shaft portion 8 also comprises a circular outer contour in a section perpendicular to the axial direction Z.

A support sleeve 1 according to the invention can be manufactured in a particularly simple and cost-effective manner. By way of example, the support sleeve 1 can be produced by the method having the following method steps:
providing a sheet-metal developed form,
freeing up a plurality of subregions of the metal strip, for example by punching, wherein the respective subregion is connected to the rest of the metal strip via a connecting portion in such a way that the respective subregion can be bent out in relation to the rest of the metal strip. In particular, the connecting portion is connected to the third shaft portion 8.
bending out the subregions in relation to the rest of the metal strip, in relation to the rest of the metal sheet in the present case,
bending the metal strip or the sheet-metal developed form in such a way that the metal strip forms a radially encircling wall for the purpose of forming the shaft 5, wherein the bent-out subregions form retaining elements 9 which protrude radially outward in relation to the rest of the metal strip.

That which is claimed is:

1. A support sleeve for supporting spaced-apart components or component portions, wherein the support sleeve is of one-part form, wherein the support sleeve comprises a shaft having a first shaft portion, a second shaft portion adjoining the first shaft portion in an axial direction, and a third shaft portion adjoining the second shaft portion in the axial direction, wherein the third shaft portion forms an end of the support sleeve, wherein the second shaft portion comprises at least one retaining element that protrudes radially outward in relation to the first shaft portion and the third shaft portion and can be deformed radially inward counter to a restoring force, and wherein the shaft comprises a slot over an axial length of the shaft.

2. The support sleeve according to claim 1, wherein the slot extends over the entire axial length of the shaft.

3. The support sleeve according to claim 1, wherein the slot is rectilinear.

4. The support sleeve according to claim 1, wherein the shaft comprises exactly one slot that extends over the entire axial length of the shaft.

5. The support sleeve according to claim 1, wherein at least one of the third shaft portion and the first shaft portion is free of any other material weakening apart from the slot.

6. The support sleeve according to claim 1, wherein a subregion of the first shaft portion protrudes in relation to the at least one retaining element counter to the axial direction.

7. The support sleeve according to claim 1, wherein the third shaft portion has a constant cross section and wherein the shaft has a constant cross section over the entire axial length of the shaft except for in the region of the at least one retaining element.

8. The support sleeve according to claim 1, wherein the at least one retaining element comprises a plurality of retaining elements arranged in a plane in the axial direction.

9. The support sleeve according to claim 1, wherein the support sleeve further comprises a head portion, wherein the first shaft portion adjoins the head portion in the axial direction, wherein the head portion protrudes radially outward in relation to the third shaft portion.

10. The support sleeve according to claim 1, wherein the radial protrusion of the at least one retaining element increases counter to the axial direction.

11. The support sleeve according to claim 1, wherein the shaft has an outer contour in a section plane perpendicular to the axial direction, and wherein the outer contour is circular or elliptical.

12. The support sleeve according to claim 1, wherein the at least one retaining element comprises a plurality of retaining elements in the form of webs, wherein the respective web is connected in the region of an end of the web, in particular in the region of an end of the web facing the third shaft portion and the other end of the respective web is a free end, wherein the second shaft portion comprises a respective aperture for receiving the respective web when the respective web is being radially inwardly deformed, and wherein the respective aperture has a tangential extent that is greater than a tangential extent of the respective web.

13. The support sleeve according to claim 1, wherein the shaft of the support sleeve is formed by a bent metal strip, and wherein the at least one retaining element is formed by a bent-out subregion of the metal strip.

14. The support sleeve according to claim 1, wherein the shaft of the support sleeve is composed of a spring steel.

15. A method for producing a support sleeve comprising the following method steps:
providing a planar, metal strip;
freeing up at least one subregion that is connected to metal strip via a connecting portion in such a way that the at least one subregion can be bent out in relation to the metal strip;
bending out the at least one subregion in relation to the metal strip; and
bending the metal strip in such a way that the metal strip forms a radially encircling wall, wherein the bent-out at least one subregion forms at least one retaining element that protrudes radially outward in relation to the metal strip.

16. An arrangement comprising a support sleeve, a hollow body and a fastening means, wherein the hollow body comprises two walls spaced apart in an axial direction, wherein a first wall of the two walls comprises a first through-opening and a second wall of the two walls comprises a second through-opening situated opposite the first through-opening in the axial direction, wherein the support sleeve passes through the first through-opening of the first wall, wherein at least one retaining element is arranged on a first side of the first wall facing the second wall, and engages behind the first wall on a second side of the first wall facing the second wall in the axial direction, wherein the fastening means passes through the support sleeve and the first and second through-openings, wherein the fastening means comprises a respective stop element on the mutually averted sides of the two walls, and wherein the respective stop elements can be adjusted in relation to each other in the axial direction.

17. The support sleeve according to claim 1, wherein the slot is configured parallel to the axial direction.

18. The support sleeve according to claim 9, wherein the head portion protrudes radially outward in relation to the at least one retaining element.

19. The support sleeve according to claim 10, wherein the at least one retaining element is of wedge-like form.

20. The support sleeve according to claim 11, wherein the outer contour of the shaft in the section plane perpendicular to the axial direction has the shape of a polygon with rounded corners.
